(19) United States
(12) Patent Application Publication
(10) Pub. No.: US 2026/0243347 A1
(43) Pub. Date: Aug. 20, 2026

(54) GASKET WITH TOLERANCE COMPENSATION ZONE

(71) Applicant: Dätwyler Schweiz AG, Schattdorf (CH)

(72) Inventors: Andreas PROKSCH, Steinach (DE); Dan Constantin STEFANOIU, Oberägeri (CH)

(73) Assignee: Dätwyler Schweiz AG, Schattdorf (CH)

(21) Appl. No.: 19/159,700

(22) PCT Filed: Feb. 20, 2024
(86) PCT No.: PCT/CH2024/050007

§ 371 Date: Aug. 26, 2025

(30) Foreign Application Priority Data
Feb. 27, 2023 (CH) 000199/2023

(51) Int. Cl. F16J 15/02

(52) U.S. Cl. CPC F16J 15/024

(57) ABSTRACT

A gasket for sealing a space between two mating surfaces has elongated longitudinal sections of moulded elastomer forming at least part of a circumferential, continuous sealing profile of the gasket. The sealing profile includes first and second sealing sides with the first and second sealing sides each forming part of a first and second continuous sealing surface for contacting the two mating surfaces. The sealing profile also includes an inner side and an outer side, with at least one of the elongated longitudinal sections provided with at least one tolerance compensation zone. The tolerance compensation zone is formed by a narrowed bridge portion spanning a width of the sealing profile from the inner side to the outer side of the sealing profile and forming part of the first and second continuous sealing surface, wherein the at least one elongated longitudinal section is not stabilized by a rigid part.

### FIELD OF THE INVENTION

The invention relates to a gasket for sealing a space between two mating surfaces of a large size.

### BACKGROUND OF THE INVENTION

Gaskets for sealing a space between two mating surfaces of large size are known in several variations. Many of these static sealings are flat gaskets cut out from a sheet material, such as paper, rubber, silicone, metal, cork, felt, neoprene, nitrile rubber, fiberglass, polytetrafluoroethylene (PTFE) or a plastic polymer.

When moulding large, elongated elastomer strands manufacturing tolerances due to shrinkage of the elastomer material becomes particularly relevant. Already at length of approx. 30 centimetres the tolerances may be too large to perfectly fit the sealing gasket to the mating surfaces. This effect can be partially reduced by an oversize of the moulds. However, because the shrinkage also depends on the materials used, one would need a different mould for each material.

The disadvantage of the large tolerance ranges becomes especially prominent when at least one of the two mating surfaces, e.g. the cover of a housing, is not flat but is provided with corrugations such as stiffening ribs. In such a case, the sealing surfaces, which are adapted to the corrugations, must be placed very precisely to guarantee a proper sealing. U.S. Pat. No. 5,590,888 describes a gasket for the gas-tight mounting of an intake manifold on the cylinder head of an internal combustion engine. The gasket is made of an elastomeric material and comprises several circumferential sealing areas for sealing several individual intake pipes arranged next to each other. The individual sealing areas are small and tolerances within the sealing area are not problematic. For easier and correct application of the individual sealing areas with respect to each other, two adjacent sealing surfaces may be connected by way of a linear tolerance compensation segment for a proper positioning of the individual circumferential sealing surfaces over the intake pipe. A sealing action within the compensation segment is not needed and is also not sufficient due to the long and relatively unstable multi-wave-like structure of the compensation segment.

FR3067436 describes a so-called foldable gasket with a plurality of rigid segments each comprising a rigid part secured to an elastomeric material. Two adjacent rigid parts being connected by at least one flexible, elongated wave-like binding member. Although the gasket is used for sealing large housings, manufacturing tolerances of the elastomeric material does not pose a problem, because of the rigid segments securing the elastomeric material. In addition, the flexible binding members having a multi-wave-like structure are relatively unstable and prone to improper sealing.

### SUMMARY OF THE INVENTION

It is an objective of the invention to provide a gasket having a plurality of elongated sections of moulded elastomer forming at least part of a circumferential, continuous sealing profile, which does not have the above problems of the prior art.

At least one of the objectives of the present invention is achieved by a gasket for sealing a space between two mating surfaces as disclosed herein. The gasket has a plurality of elongated sections of moulded elastomer forming at least part of a circumferential, continuous sealing profile of the gasket. The sealing profile comprises a first sealing side and a second sealing side arranged opposite the first sealing side. The first sealing side and the second sealing side each form part of a first and second continuous sealing surface for contacting the two mating surfaces. The sealing profile further comprises an inner side and an outer side. At least one of the elongated longitudinal sections is provided with at least one tolerance compensation zone formed by a narrowed bridge portion spanning a width of the sealing profile from the inner side to the outer side of the sealing profile and forming part of the first and second continuous sealing surface. Thus, the narrowed bridge portion spanning a width of the sealing profile may form a bridge within a section of the gasket or between sections of the gasket. The at least one elongated longitudinal section is not stabilized in length by a rigid part. In other words, the at least one elongated longitudinal section does not include a length stabilizing rigid part or insert. The at least one elongated longitudinal section may have a length of 200 mm or more, preferably at least 300 mm.

The two mating surfaces may be e.g. parts of a housing but also other mating parts such as large battery or charging plates or chassis.

Such gaskets with elongated elastomer sections, i.e. section which are not stabilized in length with a rigid insert, are subject to considerable manufacturing tolerances. At a length of the elongated sections of approx. 300 mm or more, the manufacturing tolerances may become too large for proper placement of the sealing surface, e.g. in corner regions, and to guarantee proper sealing. The tolerance compensation zone with the bridge portion can compensate for such manufacturing tolerances in length of the elongated section, in that they act as flexible zones, which may be stretched (or compressed) by bending the bridge portion in the corners where it is attached to the sealing profile at the inner and/or outer side. Thus, the tolerance compensation zone is designed such that the gasket can be stretched (or compressed) along the elongated section by a few millimetres without getting thinner. The first and second sealing surfaces continue along both sides the relatively short bridge portion and provide a proper sealing towards the mating surfaces of the housing. The compensation zones can be designed relatively short in length and are therefore very stable even under compression of the gasket.

The sealing profile may have a rectangularly shaped cross-section. A height of the sealing profile is defined by the distance between the first and second sealing surfaces and may be in the range of 5 to 20 millimetres. A width of the sealing profile is defined by the distance between the inner and outer side and perpendicular to the height. The width may be in the range of 10 to 25 millimetres. The bridge portion typically has the same height as the sealing profile but is a narrower section with a thickness (perpendicular to the height) smaller than the width of the sealing profile. In other words, the bridge portion has the same height as the adjacent regions of the elongated section. The thickness of the bridge portion may be in the range of 2 to 4 mm.

Further embodiments of the invention are disclosed herein.

In some embodiments the tolerance compensation zone may comprise one single bridge portion spanning the width of the sealing profile from the inner side to the outer side of the sealing profile. When the tolerance compensation zone is stretched or compressed, bending of the bridge portion occurs in the corner where it is attached to the adjacent portions of the elongated longitudinal section. The bridge portion may form a straight bridge.

In some embodiments the tolerance compensation zone may comprise two joining bridge portions attached to the elongated longitudinal section on the inner or outer side of the sealing profile and spanning the width of the sealing profile. The two bridge portions thus form a V-shaped bridge. The bending when stretched or compressed occurs additionally in the tip of the V-shaped bridge.

In some embodiments the bridge portion may be arranged perpendicular to the longitudinal axis of the elongated longitudinal section or at an angle of 60 to 90 degrees to the longitudinal axis of the elongated longitudinal section. In this way, the tolerance compensation zone may be built in a very short and stable manner.

In some embodiments the bridge portion may be formed by a cut-out of the sealing profile on the inner side and a cut-out of the sealing profile on the outer side.

In some embodiments the tolerance compensation zone may have a length of approx. 5 to 25 mm, preferably approx. 15 to 25 mm, and is stretchable along the longitudinal axis of the elongated longitudinal section by approx. 1 to 5 mm.

In some embodiments the length of the tolerance compensation zone may be about 0.5 to 2.0 times the width of the sealing profile. Preferably the length of the tolerance compensation zone may be smaller than the width of the sealing profile. In this way, good sealing function and stability of the gasket have been achieved.

In some embodiments the at least one tolerance compensation zone may be arranged at an end of the elongated longitudinal section or within the elongated longitudinal section, e.g. in a centre region of the elongated longitudinal section. At least one of the elongated longitudinal sections may be provided with two or more tolerance compensation zones spaced apart by 200 mm or more, preferably at least 300 mm. The number of the tolerance compensation zones depends mainly on the length of the elongated longitudinal sections. The longer the section the higher are the expected tolerances to be compensated. If sealing has to be very accurate, e.g. due to a non-flat mating surface of the housing, the more tolerance compensation zones may be arranged.

When the compensation zone is arranged within the elongated longitudinal section, the bridge formed by one or more bridge portions may be connected on both sides to the elongated longitudinal section. When the compensation zone is arranged at an end of the elongated longitudinal section, the bridge formed by one or more bridge portions may be connected on one side to the elongated longitudinal section and on the other side to another section of the gasket, e.g. a corner section.

In some embodiments the elongated longitudinal sections may comprise at least two sealing lips. The at least two sealing lips may be an inner sealing lip and an outer sealing lip each on the first sealing side and/or the second sealing side. These sealing lips form part of the first and second continuous sealing surface and may compensate tolerances and unevenness of the mating surfaces of the housing. The inner sealing lip and the outer sealing lip may converge to one single sealing lip arranged along the bridge portion of the tolerance compensation zone. The elongated longitudinal sections may comprise a third central sealing lip on the first sealing side and/or the second sealing side arranged between the inner sealing lip and the outer sealing lip.

In some embodiments the entire gasket or the entire sealing profile may be of elastomer material. Some parts of the gasket may be provided with rigid or flexible inserts, e.g. for folding the gasket or attachment of the gasket.

The rigid inserts may be small bushings for attachment or elongated rigid inserts or parts for stabilizing a section of the gasket by creating a high stiffness. Such elongated rigid inserts are typically over-moulded with elastomer and prevent or at least considerably reduce the problem of manufacturing tolerances. The elongated rigid inserts may be arranged in the centre area of an elongated longitudinal sections of the gasket.

The at least one elongated longitudinal section, which is provided with a tolerance compensation zone, is not stabilized in length by a rigid part, because an elongated rigid part would already reduce the problem of manufacturing tolerances and therefore a tolerance compensation zone would not be required.

The gasket and the elongated sections with a tolerance compensation zone may however comprise bushings for attachment of the gasket to another structure, e.g. a housing. The bushings are small hollow, cylindric parts preferably having a circumferential flange on both sides. Such bushings provide an opening in the gasket for attachment and have no stabilizing effect like the elongated rigid inserts. Such bushings cannot avoid or reduce the problem of manufacturing tolerances. Bushings may be spaced apart by 80 to 120 mm.

In some embodiments the gasket may comprise a plurality of corner sections arranged between and connecting the plurality of elongated longitudinal sections. These corner sections may also be provided with sealing lips. The height and width may be the same as for the elongated longitudinal sections.

In some embodiments the elastomer material is a natural rubber or a synthetic rubber, such as butyl rubber or halogenated butyl rubber (e.g. bromobutyl rubber), isoprene rubber, butadiene rubber, ethylene propylene copolymer rubber, ethylene-propylene-diene monomer rubber, silicone rubber, fluoro silicone rubber, fluoro-or perfluoro-rubbers, chlorosulfonate, acrylonitrile butadiene rubber, halogenated acrylonitrile butadiene rubber, carboxylated acrylonitrile butadiene rubber, styrene butadiene rubber, ethylene acrylic rubber and polyacrylic rubber, and blends and combinations thereof. The term “synthetic rubbers” also should be understood to encompass materials which alternatively may be classified broadly as thermoplastic or thermosetting elastomers such as polyurethanes, silicones, fluorosilicones, styrene-isoprene-styrene copolymer, and styrene-butadiene-styrene copolymer, as well as other polymers which exhibit rubber-like properties such as plasticized nylons, polyolefins, polyesters, ethylene vinyl acetates, fluoropolymers, and polyvinyl chloride.

### BRIEF DESCRIPTION OF THE DRAWINGS

The invention is described in greater detail below with reference to embodiments that are illustrated in the figures. The figures show:

FIG. 1 a top view of a gasket with a tolerance compensation zone;

FIG. 2 a sectional view of a sealing profile of the gasket of FIG. 1;

FIG. 3 a detailed view of the tolerance compensation zone;

FIGS. 4A and 4B variants of a tolerance compensation zone.

### EMBODIMENTS OF THE INVENTION

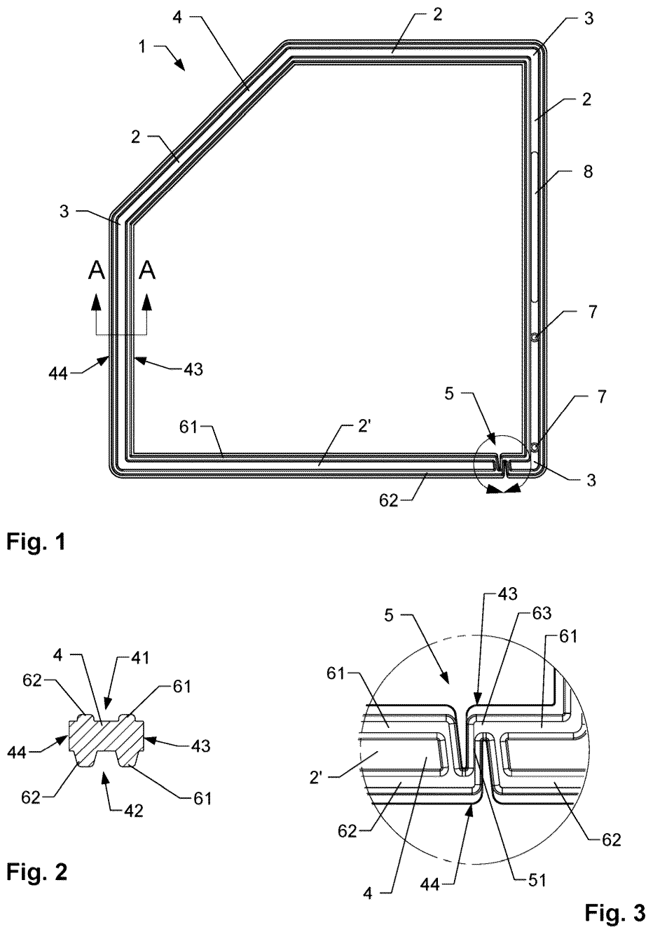

FIG. 1 shows a top view of a gasket 1 for sealing a space between two mating surfaces of a housing (or between two charging plates or chassis). The gasket 1 has a plurality of elongated longitudinal sections 2 connected to each other by a plurality of corner sections 3. These sections together form a circumferential, continuous sealing profile 4 having a first sealing side 41 on the top (visible side), a second sealing side 42 (see FIG. 2), an inner sealing side 43 facing an interior of the housing and an outer side 44 facing an exterior of the housing. The first and second sealing side form a first and second sealing surface against the two mating surfaces of the housing. The gasket shown in FIG. 1 has at least one longitudinal section 2′ with a length of approx. 300 mm, which is made entirely of elastomer material. To compensate for manufacturing tolerance in the length of the elongated longitudinal section 2′ the gasket as shown is provided with a tolerance compensation zone 5, which is located in an end region of the elongated longitudinal section 2′ near a corner section 3 (bottom right corner). The at least one elongated longitudinal section 2′ with the tolerance compensation zone 5 does not have a stabilizing elongated insert 8.

The gasket in FIG. 1 is further provided with an inner sealing lip 61 and outer sealing lip 62 on both sealing sides 41, 42 of the sealing profile 4. These sealing lips 61, 62 are also shown in FIG. 2. The sealing profile of FIG. 2 has a width of approx. 15 to 20 mm (from inner side to outer side) and a height of approx. 10 to 15 mm (from first to second sealing surface). Smaller or larger dimensions are also possible.

Some elongated longitudinal sections 2 may be provided with bushings 7 for attachment of the gasket to another structure, e.g. a housing, and/or elongated stabilizing inserts 8 for stabilizing a section of the gasket by creating a high stiffness. Such elongated stabilizing inserts 8 may reduce the problem of manufacturing tolerance as long as sections between or next to such stabilizing inserts have a small enough length to avoid the problem of manufacturing tolerances. The bushings 7 however are small hollow, cylindric parts preferably having a circumferential flange on both sides. Such bushings provide an opening in the gasket for attachment and have no stabilizing effect like the elongated rigid inserts. Such bushings cannot avoid or reduce the problem of manufacturing tolerances.

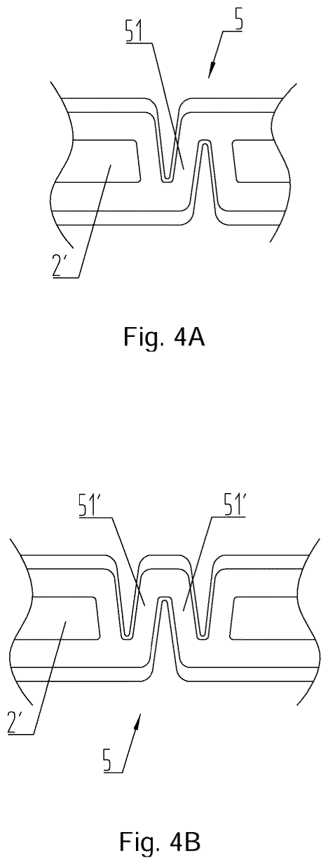

FIG. 3 shows a detailed view of the tolerance compensation zone 5. The tolerance compensation zone 5 is formed by a narrow bridge portion 51, which spans the width of the sealing profile 4 from the inner side 43 to the outer side 44 and forms a straight bridge. In the embodiment shown, the bridge portion 51 is perpendicular to the longitudinal axis of the elongated longitudinal section 2′ and formed by cut-out on the inner side 43 and a cut-out on the outer side 44 of the sealing profile 4. However, the bridge portion may also be at an angle of 60 to 90 degrees to the longitudinal axis of the elongated longitudinal section (see FIGS. 4A and 4B).

The inner and outer sealing lips 61, 62 converge near the bridge portion into one single sealing lip 63, which runs along the bridge portion 51. On the other side it diverges again into an inner and outer sealing lip 61, 62. In the shown example, the length of the tolerance compensation zone is approx. 8 to 10 mm but may have a shorter or larger range depending on the angle of the bridge portion or the overall dimension of the sealing profile. The bridge portion itself is approx. 2 to 4 mm thick. A tolerance compensation zone as shown in FIG. 3 is very stable and provides proper sealing between two mating surfaces of a housing.

FIGS. 4A and 4B show detailed views of two variants of the tolerance compensation zone 5. In the variant of FIG. 4A a straight bridge is formed by one bridge portion 51, which is at an angle of approx. 80 degrees to the longitudinal axis of the elongated longitudinal section 2′. In the variant of FIG. 4B a V-shaped bridge is formed by two bridge portions 51′. In the shown variant the bridge portions 51′ are at an angle of approx. 80 degrees to the longitudinal axis of the elongated longitudinal section 2′.

### REFERENCE SIGNS

1 gasket
2 elongated longitudinal section
2′ elongated longitudinal section without stabilizing insert 8
3 corner section
4 sealing profile
41 first sealing side
42 second sealing side
43 inner side
44 outer side
5 tolerance compensation zone
51, 51′ bridge portion
61 inner sealing lip
62 outer sealing lip
63 sealing lip
7 bushing
8 elongated stabilizing insert

1-14. (canceled)

15. A gasket for sealing a space between two mating surfaces, the gasket comprising:
a plurality of elongated longitudinal sections of moulded elastomer forming at least part of a circumferential, continuous sealing profile of the gasket,
wherein the sealing profile comprises a first sealing side and a second sealing side arranged opposite the first sealing side,
wherein the first sealing side and the second sealing side each form part of a first and second continuous sealing surface for contacting the two mating surfaces,
wherein the sealing profile further comprises an inner side and an outer side,
wherein at least one of the plurality of elongated longitudinal sections is provided with at least one tolerance compensation zone,
wherein the tolerance compensation zone is formed by a narrowed bridge portion spanning a width of the sealing profile from the inner side to the outer side of the sealing profile (4) and forming part of the first and second continuous sealing surface,
wherein the at least one elongated longitudinal section is not stabilized by a rigid part.

16. The gasket according to claim 15, wherein the tolerance compensation zone comprises one single bridge portion spanning the width of the sealing profile from the inner side to the outer side of the sealing profile.

17. The gasket according to claim 15, wherein the tolerance compensation zone comprises two joining bridge portions attached to the elongated longitudinal section on the inner or outer side of the sealing profile.

18. The gasket according to claim 15, wherein the bridge portion is arranged perpendicular to the longitudinal axis of the elongated longitudinal section or at an angle of 60 to 90 degrees to the longitudinal axis of the elongated longitudinal section.

19. The gasket according to claim 15, wherein the bridge portion is formed by a cut-out of the sealing profile on the inner side and a cut-out of the sealing profile on the outer side.

20. The gasket according to claim 15, wherein the tolerance compensation zone has a length of about 5 to 25 mm and is stretchable along the longitudinal axis of the elongated longitudinal section by about 1 to 5 mm.

21. The gasket according to claim 15, wherein the length of the tolerance compensation zone is about 0.5 to 2.0 times the width of the sealing profile.

22. The gasket according to claim 15, wherein the at least one tolerance compensation zone is arranged at an end of the elongated longitudinal section or within the elongated longitudinal section.

23. The gasket according to claim 15, wherein at least one of the elongated longitudinal sections is provided with two or more tolerance compensation zones spaced apart by 200 mm or more.

24. The gasket according to claim 15, wherein the elongated longitudinal sections comprise an inner sealing lip and an outer sealing lip each on the first sealing side and/or the second sealing side.

25. The gasket according to claim 24, wherein the inner sealing lip and the outer sealing lip converge to one single sealing lip arranged along the bridge portion of the tolerance compensation zone.

26. The gasket according to claim 15, wherein the entire gasket or the entire sealing profile is of elastomer material.

27. The gasket according to claim 15, wherein the gasket comprises a plurality of corner sections arranged between and connecting the plurality of elongated longitudinal sections.

28. The gasket according to claim 15, wherein the elastomer material is a synthetic or natural rubber.

29. The gasket according to claim 21, wherein the length of the tolerance compensation zone is smaller than the width of the sealing profile.
